(19) United States
(12) Patent Application Publication
(10) Pub. No.: US 2018/0295958 A1
(43) Pub. Date: Oct. 18, 2018

(54) Secure Enclosure Derived from Aluminum Can with Slot Cover

(71) Applicant: David Allen Tucker, Dallas, TX (US)

(72) Inventor: David Allen Tucker, Dallas, TX (US)

(21) Appl. No.: 15/488,271

(22) Filed: Apr. 14, 2017

(51) Int. Cl. A45C 1/12; G07F 9/06; G07F 1/02; G07F 1/04

(52) U.S. Cl. CPC A45C 1/12; G07F 1/04; G07F 1/02; G07F 9/06

(57) ABSTRACT

A piggy bank, collection box, or ballot box made from an aluminum can having a slot made near its upper outer rim; preferably having a cover thereon, and preferably one themed for a fundraising or saving purpose or being the terminus of a slide.

### CROSS REFERENCE TO RELATED APPLICATIONS

Tools for Up-Cycling Beverage Cans into Art Objects, Toys, and Other Items, by David Allen Tucker, application Ser. No. 15/293,276, filed Oct. 14, 2016.

### STATEMENT OF FEDERALLY SPONSORED RESEARCH OR DEVELOPMENT (IF ANY)

Not applicable.

### THE NAMES OF THE PARTIES TO A JOINT RESEARCH AGREEMENT IF THE CLAIMED INVENTION WAS MADE AS A RESULT OF ACTIVITIES WITHIN THE SCOPE OF A JOINT RESEARCH AGREEMENT

Not applicable.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

Not applicable.

### BACKGROUND OF THE INVENTION

### A. Field of the Invention

The present invention relates to up-cycling a beverage can into a collection box or piggy bank or ballot box.

### B. Description of the Prior Art

For decades, if not centuries, people have used all kinds of cans and jars as receptacles for collecting charitable donations or ballots or as piggy banks. The typical receptacle is either open at the top, or has a removable top, or is closed with a slot in the top for inserting coins or bills or ballots. The open or openable design is deficient because it is a security risk. Anyone entrusted with the receptacle can secretly remove the ballots or funds—often with no evidence of tampering with the receptacle or its contents. Also, any piggy bank that can be easily opened will fail in its purpose as a deferred-gratification enforcement mechanism. Using a well-sealed receptacle with a slot in it is superior because tampering is evident and potentially expensive. Slots are located at the top of the receptacle for the obvious reason of maximizing the ease with which it can be filled up.

Current collection boxes have limitations. Either they are made of paper (which is flimsy and cheap-looking and presents security risks and generates trash) or they are manufactured from more durable materials (which makes them expensive and sends the wrong message about your need for the donor's small change). An inexpensive aluminum beverage can could be used as a collection box or a piggy bank, but it has limitations. First, while the beverage spout hole is adequate for accepting rolled-up dollars or IOUs, it is typically manufactured at the wrong size for accepting dollar-coins, quarters and nickels. It will accept smaller coins like pennies and dimes, but these coins and bills can be easily shaken out; and the donor's knowledge of that limitation could make him or her reluctant to give. Second, feeding the beverage spout hole feels like putting trash into a can, which might inhibit donations as well. Of course one might want to punch a slot in the top of the beverage can, but it is difficult to do so without serious tools and without damaging either the can or its appearance. The metal of the beverage can is strongest at its top and bottom, making slot-making there difficult.

There is a need for a collection box which is durable, inexpensive, tamper evident, environmentally sound, professional-looking, recyclable, fun, and cute. It would also be desirable to have a collection box for which the act of donating sends a psychological message about the cause for which one is raising funds. It would be desirable to have a collection box in which the act of putting money into it did not feel like filling a trash can.

### BRIEF SUMMARY OF THE INVENTION

I invented a better receptacle for serving as a collection box, piggy bank or ballot box (hereinafter, a “secure enclosure”). In its ideal configuration, the secure enclosure is made from an empty but mainly-sealed aluminum beverage can 5, a can slot 6 located in a Goldilocks zone 1 in the side of the can 5, and a slot cover 2 that has a rear anchoring plug 4 and a slot cover opening 3. See FIGS. 3 and 4. The slot cover 2 ideally has a cute design that sends a message about the purpose for which one is raising funds, such as a cross, Star of David, football, baseball, school item, and so on.

To make the secure enclosure, a pushpin is first used to make two starter holes in the Goldilocks zone 1 for inserting anchoring plugs 4 of slot cover 2, and then those anchoring plugs 4 are pushed inside the starter holes until the slot cover 2 sits firmly against the can. A slot-maker 7 (See FIG. 4) is then pushed through slot cover 2 and dragged within the slot cover opening 3 to make a can slot 6 for inserting cash, papers, and coins. The slot cover 2 can be a plain border, or it can be themed to match the fundraising purpose. For example, the slot cover 2 could be in the shape of: (i) a cross, with the can slot located in the horizontal portion; (ii) a football, with the can slot located where the laces should be; (iii) a Star of David, with the can slot located within its top bar; (iv) a helical slide 9 (FIG. 5), with the can slot at the base of the slide where a coin would fall; (v) a baseball bat, with the can slot located along the bat's length; (vi) a badge; or (vii) a book. The foregoing list is illustrative and not limiting.

In main part, my new secure enclosure is inventive because of: (a) the placement of the slot cover in the Goldilocks zone, which is counter-intuitive, (b) the use of the slot-cutting tool, and (c) the slot cover. It is counterintuitive to think that a side-facing slot would be superior to a top-facing one, but it is. This is because of my insights that (i) in a modern US can, the area just above the Goldilocks zone is rigid enough to support the can's structure without dents or creases in the main body of the can as the slot-cutting tool and the plugs do their work and (ii) the area within the Goldilocks zone is soft enough for the slot-cutting tool to penetrate and tear easily. All other areas of the can would be too rigid for the slot-cutting tool and plugs to function well or they would be too malleable or they would be near the bottom of the can. Trying to put a slot anywhere else in the side of the can would lead to undesirable and unaesthetic dents and creases in the can. Also, using the Goldilocks zone for slot placement makes the user present the can and its messaging (such as stickers on the side of the can) toward the potential donor. The slot-cutting tool is also inventive in its own right, but it has been claimed and explained in my prior patent application (application Ser. No. 15/293,276), which is incorporated herein by this reference as if set out in full. Basically, the slot-cutting tool functions well in its purpose of making slots in aluminum cans and is exceedingly simple to use and manufacture. The slot cover is inventive as well because it is a new and simple messaging method that makes the can (and therefore donations or deposits) more attractive. It also hides the jagged sharp edge where the slot-maker did its work.

So, my invention is superior to the current state of the art for collection boxes and piggy banks because an aluminum can is inexpensive, inexpensive-looking, readily available, recyclable after use, sturdy, attractively colored, attractively shaped, easily handheld, tamper evident, lightweight, stackable, fireproof, and waterproof, and because it is filled with a beverage you'll get to enjoy before using it. It is also particularly suitable for charitable fundraising by the beverage company which makes the can. The slot located in the Goldilocks zone is superior because it is easy and fast to make, and it is positioned away from where liquids are likely to pool.

The slot cover located in the Goldilocks zone is a beneficial improvement because it makes the fundraising can look like a cleanly-manufactured product (as opposed to trash); it helps with messaging for your fundraiser (e.g., a cross, football, baseball bat, Star of David); it doesn't bend or dent the can when being made; it is easy to make and apply; it makes the can look more fun and attractive; it makes the act of giving fun (e.g., coin slide configuration; FIG. 5); it makes the user tilt the side of the can toward the donor, thereby displaying messaging on the slot cover and on the can (which could be stickered with a fundraising pitch); and it makes donation feel like mailing an important letter—not stuffing a trash bin. My invention has all these advantages and solves all of the previously-mentioned problems, which makes it a significant advance over the prior art.

Further objects of the invention will appear as the description proceeds. To the accomplishment of the above and related objects, this invention may be embodied in the form illustrated in the accompanying drawings, attention being called to the fact, however, that the drawings are illustrative only, and that changes may be made in the specific constructions illustrated and described within the scope of the appended claims and/or this specification.

### BRIEF DESCRIPTION OF THE SEVERAL VIEWS OF THE DRAWINGS

Various other objects, features, and attendant advantages of the present invention will become fully appreciated as the same becomes better understood when considered in conjunction with the accompanying drawings, in which reference characters designate the same or similar parts throughout the several views, and wherein:

FIG. 1 is an upper perspective view of a secure enclosure with a simple slot made in the can and having a simple slot cover thereon.

FIG. 2 is a front view of a slot cover having anchoring plugs.

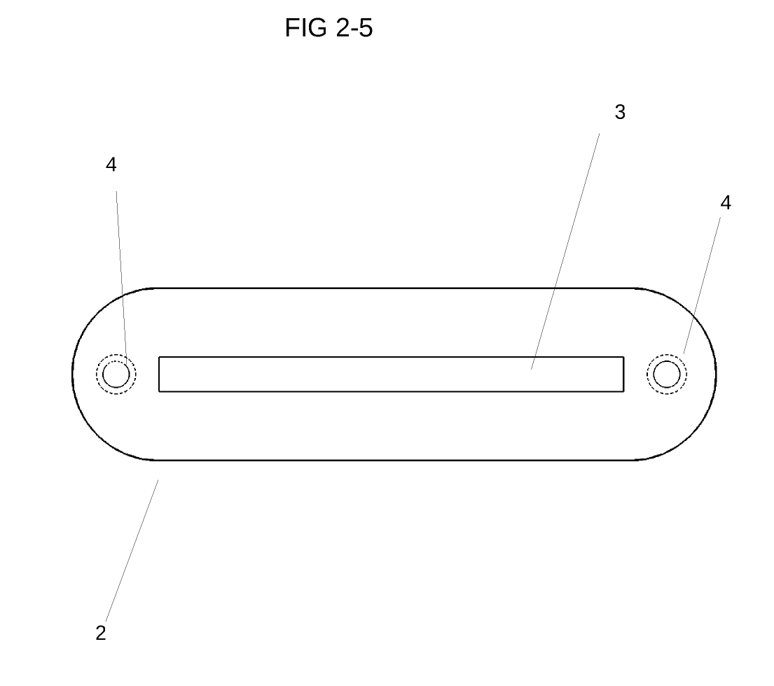

FIG. 3 is a rear perspective view of a slot cover having anchoring plugs.

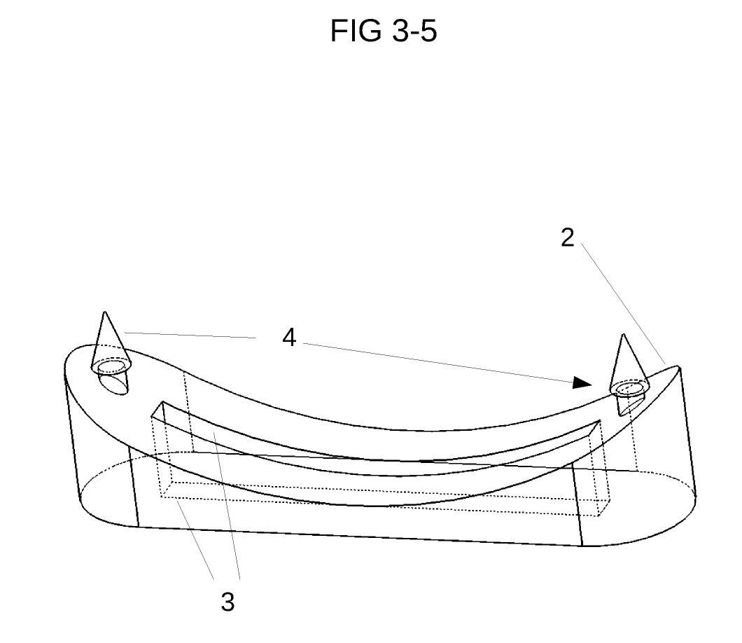

FIG. 4 is a top perspective view of the slot-maker.

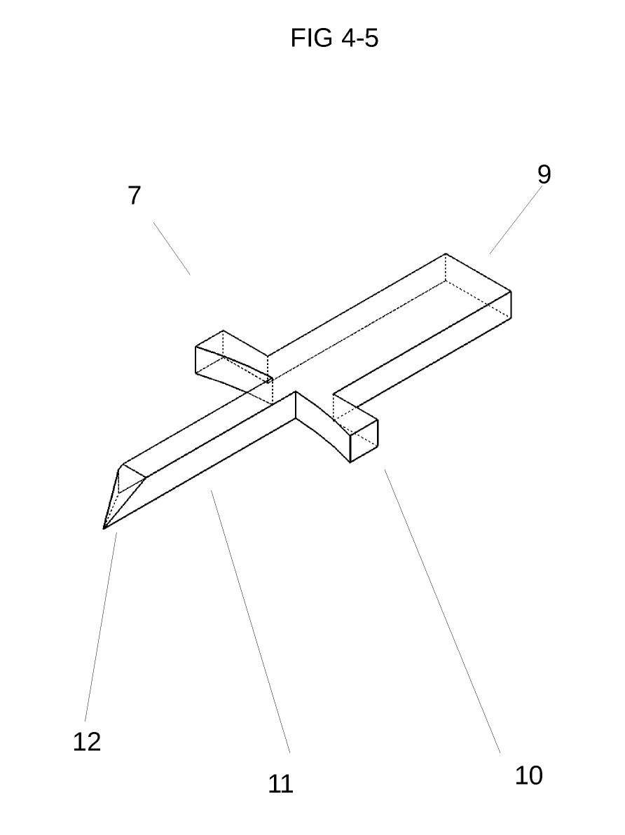

FIG. 5 is a perspective view of a slot cover that incorporates a slide.

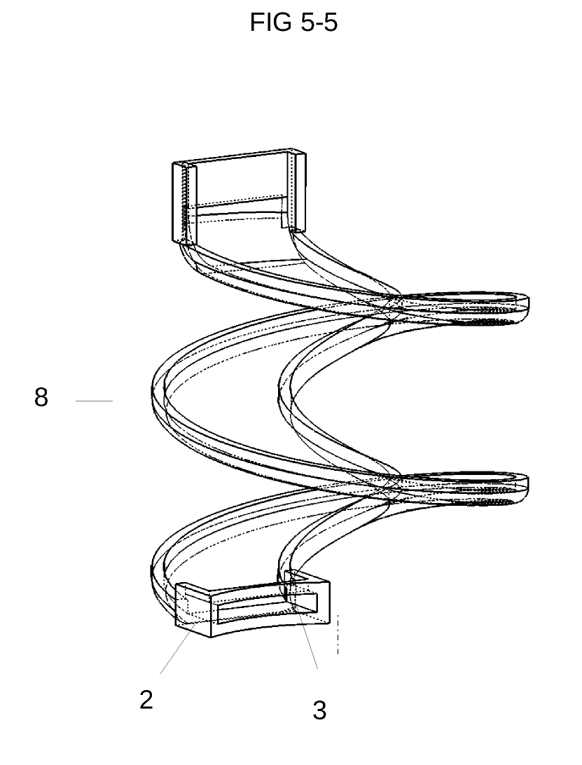

### DETAILED DESCRIPTION OF THE INVENTION

The description given above in the Brief Summary of the Invention section is hereby and herein incorporated by this reference as if stated at length. In the drawings, similar reference characters denote similar elements throughout the several views.

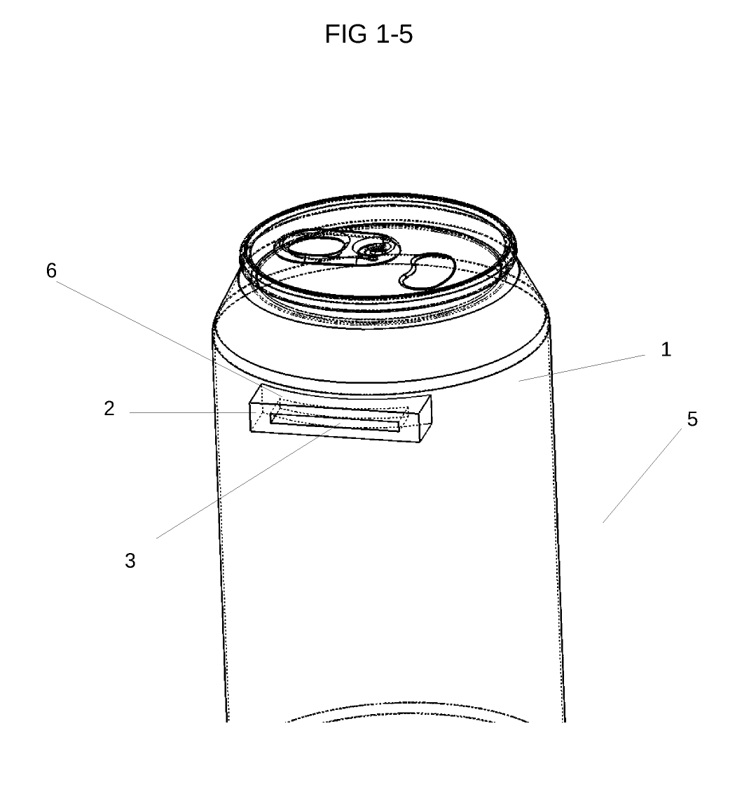

The secure enclosure is made from an ordinary aluminum beverage can 5. See FIG. 1. In its current composition, among USA bottlers, an aluminum beverage can has an outer curvature along most of its body that is approximately 65 mm in width and that, at its top, tapers down to a radius of about 47 mm. The upper ridge where the can begins to narrow in diameter is made of thicker aluminum, but the ring of space just below that (which begins a few millimeters below the tapering) is thinner, more flexible aluminum, like the sides of the can; but the material in that ring is still supported closely by the rigid upper ridge. I call the space of flexible aluminum immediately below the thick ridge the “Goldilocks zone.” This is the area in which the slot cover 2 will be located and where its anchor holes and slot will be installed.

The slot cover 2 is preferably made of a wood product or inexpensive plastic or some combination of both. It has a centrally located slot cover opening 3 in its long, horizontal direction suitable for passing coins or folded paper money or small ballots. On its rear side, it has at least one anchoring plug 4. These are designed so that when you push them into a pinhole in the can made from a pushpin, it will gently enlarge the hole. Like a sex toy, the plug is narrower at the point where the plug meets the back of the slot cover 2 so that the elasticity of the aluminum will cause the pushed-away aluminum material to pull back against the plug's shaft, thereby securing the slot cover 2 against the can. In lieu of or in addition to the anchoring plugs 4, adhesive could be used to secure the slot cover 2 against can 5.

To make the secure enclosure, one preferably first drains some or all of the liquid from the can. I like to poke an unobtrusive hole in the top with a pushpin (usually a hole concealed under the can's tab when the tab is in its normal position). Occasionally I speed the drainage by poking a small vent hole with a pushpin in the soft aluminum side of the can near the bottom.

I then insert the slot-maker 7 into the can 5 at its Goldilocks zone 1 and drag it horizontally to make a can slot 6 suitable for inserting change, folded dollars, and/or small folded ballots. Slot-maker 7 has a barrier 10 that prevents over-insertion when cutting point 12 is inserted. Slot-maker 7 also has a bottom cutting surface 11 approximately 2 to 3 mm in width between its handle 9 and its cutting point 12. This bottom cutting surface 11 acts to peel a section of can away, thereby forming the can slot 6 (which is the actual opening in the can's metal). If slot-maker 7 is not sufficiently sharp and rigid to penetrate the can 5 easily, I will first make a starter hole with a pushpin.

It is highly desirable, but not strictly necessary, to put a slot cover 2 over can slot 6. To do so, you first prick a starter hole in the Goldilocks zone 1 where an anchoring plug 4 is to be inserted. Then place anchoring plug 4 gently against that starter hole and make another starter hole in the appropriate position where the other anchoring plug 4 will land when the slot cover 2 is fully inserted in its preferred position. Gently push one anchor plug into its hole. Bend-in the slot cover slightly and insert the other plug in its hole. If properly done, the cover will snugly fit against the can; if not, use a liquid or gel adhesive to obtain a snug fit. Once the cover is in place, use slot-maker 7 and pushpin as described above to make the can slot 6 in the can underneath the slot cover 2. In lieu of anchoring plugs, the slot cover 2 could be adhered to the can 5 with a double-sided adhesive backing strip (e.g., double-sided tape or a thin foam with peel-off stickers that protect the adhesive when not in use).

Once fundraising is accomplished the can is opened by removing the slot cover with pliers. One can then scissor off the top from the Goldilocks zone 1 using the horizontal slot (i.e., the can slot) as a starting point. Alternatively, one can fold the can in half while holding it by its two ends, then bend it back and forth several times, and then twist the can so the aluminum wall tears from the can's center.

I claim:

1. An apparatus for tearing a slot in a beverage can for the purpose of making a secure enclosure comprising a substantially rigid body having a bottom cutting surface whose width is or exceeds two millimeters, and further comprising a handle connected to the body.

2. The apparatus of claim 1, wherein an end of the body terminates in a cutting point that would be suitable for either puncturing a side wall of a beverage can or for expanding a small hole previously made in the can so that the bottom cutting surface could pass partially within the can.

3. The apparatus of claim 1, further comprising a barrier between the handle and the bottom cutting surface.

4. A secure enclosure comprising an aluminum beverage can having a Goldilocks zone and a horizontal slot cut into the Goldilocks zone and which horizontal slot is wide and tall enough to permit the passage of coins and folded paper currency.

5. The apparatus of claim 4, further comprising a slot cover which is affixed to the can and which has a slot cover opening, and whereby the slot cover opening is positioned over the horizontal slot to permit the passage of coins and folded paper currency into the can through both the slot cover opening and the horizontal slot.

6. The apparatus of claim 5, further comprising a slot cover having a shape that suggests the purpose for which funds are being collected.

7. The apparatus of claim 6, wherein the shape is a cross, Star of David, soccer ball, basketball, baseball, football, goalposts, baseball bat, hockey stick, book, badge, rod of Asclepius, or substantially a two-dimensional view of any of the foregoing.

8. The apparatus of claim 5, further comprising a slot cover having a slide incorporated therewith which permits coins placed at the top of the slide to slide along its slope and drop into the slot.

9. The apparatus of claim 5, whereby the means of affixing the slot cover to the can is a plug which penetrates the can and anchors the slot in place.

10. The apparatus of claim 5, whereby the means of affixing the slot cover to the can is adhesive.

11. The apparatus of claim 10, whereby the means of affixing the slot cover to the can is a thin object coated on both sides with adhesive which is placed between the slot cover and the can and which physically connects the slot cover to the can.

12. A method of making a secure enclosure comprising the steps, in either order, of:
(i) making a substantially horizontal slot in the side of a beverage can in the can's Goldilocks zone of sufficient size and width to pass coins and folded paper money; and
(ii) affixing a slot cover to the can such that the opening in the slot cover is over the substantially horizontal slot in a manner that would permit coins and folded paper money to be passed through them.
